(19) United States
(12) Patent Application Publication
(10) Pub. No.: US 2012/0093032 A1
(43) Pub. Date: Apr. 19, 2012

(54) AIRLINK TECHNIQUES ENABLING DYNAMIC OPTIMIZATION AND CONFIGURATION OF WIRELESS NETWORK BASE STATIONS

(76) Inventor: Muthaiah VENKATACHALAM, Beaverton, OR (US)

(21) Appl. No.: 12/906,488

(22) Filed: Oct. 18, 2010

(51) Int. Cl. H04W 16/00

(52) U.S. Cl. 370/255

(57) ABSTRACT

An embodiment of the present invention provides a base station (BS), comprising a transceiver adapted for communication with at least one mobile station (MS) in a wireless network and further adapted to reconfigure RF operational parameters on a dynamic basis enabling self optimizing networks (SON), and wherein the BS is capable of maintaining session continuity with the at least one STA through SON restarts.

### CROSS REFERENCE TO RELATED APPLICATIONS

This application claims the benefit of U.S. provisional application No. 61/236,056, Attorney Docket No. PRFBT082109Z, filed Aug. 21, 2009, entitled, “Airlink enhancements for dynamic optimization and configuration of the 802.16m BS”, invented by Muthaiah Venkatachalam.

### BACKGROUND

SON (self optimizing networks) is an emerging technology for wireless networks such as, but not limited to, WiMAX and other wireless technologies. The basic idea is that a SON server in a network can reconfigure the RF operational parameters of a WiMAX (or other wireless technology) base station (BS) on a dynamic basis.

For example, RF carrier, FFR info, transmit power etc. may be reconfigured in a dynamic way. Some of these parameter updates will need the restart of the BS operation. If a mobile station (MS) is being serviced in the BS when this reconfiguration or restart has to happen, then the MS session can be lost.

Thus, a strong need exists for a mechanism to not lose the session continuity of MS during such restarts due to SON updates.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a procedure for improved airlink techniques enabling dynamic optimization and configuration of wireless network base stations according to embodiments of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the preset invention may be practiced without these specific details. In other instances, well-known methods, procedures, components and circuits have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

Embodiments of the present invention provide mechanisms to ensure that an MS session is preserved through the SON restarts. Embodiments of the present invention may be applicable to wireless networks, including those that conform to the Institute for Electronic and Electrical Engineers (IEEE) 802.16 standard (also may be referred to herein as WiMAX).

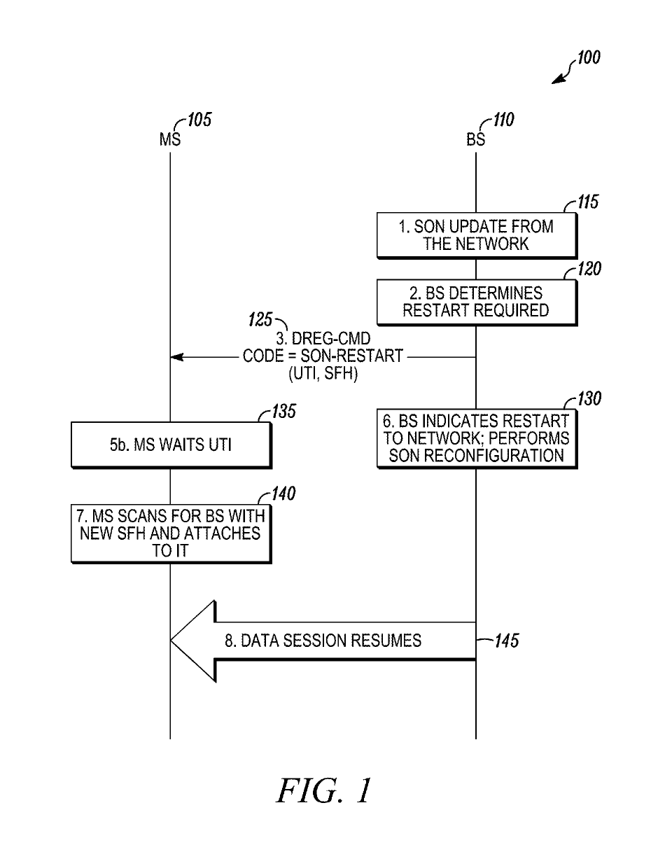

Looking now at FIG. 1, shown generally as 100, is an illustration of a first embodiment of the present invention which provides using DREG-CMD to solve this problem. When the BS 110 is being asked to restart its operation by the SON server, the BS 110 can send a Deregistration command (DREG-CMD) 125 message to all the MSs 105 that are attached to it. A new DREG-CMD 125 code shall be defined and used for this specific purpose of SON restart of the BS 110. When this code is used in the DREG-CMD 125 and the MS 105 receives the same, the MS 105 will immediately know that this de-registration is for SON purposes and hence it is a temporary one.

As part of this DREG-CMD 125, following information is included: a) Unavailable time Interval (UTI) of the BS; b) New system parameters of BS (post reconfig) for network re-entry of the MS 105. In order to maintain the session continuity of the MS 105, BS 110 also indicates this restart to the ASN-GW to start buffering the data in the GW for the MS 105.

BS 110 and MS 105 maintain the MAC context after DREG-CMD 125 to enable fast network re-entry. At 130 BS indicates restart to network; performs SON reconfiguration. MS 105 gets this DREG-CMD 125 message and deregisters itself from the BS 110. It waits until UTI expires 135, then it scans 140 for the BS 110 again with the new system parameters. MS 105 performs fast re-entry with existing MAC context and an MS Session is not lost and at 145 data session resumes.

Benefits of this first embodiment of the present invention are there is no broadcast overhead and all the connected users can be notified. However idle and scanning users may be missed with this approach.

A second embodiment of the present invention provides broadcasting the relevant info for re-attach. Before the SON reconfiguration, the BS broadcasts the following info: a) Unavailability start time (UST); b) Unavailable Time Interval (UTI) of the BS; and c) New system parameters for network re-entry of the MS, once the BS becomes available (this step may be optional).

BS also may indicate this to the ASN-GW to start buffering the data in the GW for the MS. In order to maintain the session continuity of the MS, BS also indicates this restart to the ASN-GW to start buffering the data in the GW for the MS. All attached MSs get this message and detach themselves from the BS starting UST. Then they wait until UTI expires. Then they scan for the BS again with the new system parameters. MS then performs fast re-entry with existing MAC context and the MS Session is not lost.

Benefits of this embodiment of the present invention are that all users (connected, idle, scanning) can be potentially reached. However there are no guarantees that everyone will read this broadcast and unicast overhead is not present.

Still another embodiment of the present invention provides a hybrid approach of the aforementioned embodiments wherein a BS unicasts the UTI+system parameters to all attached MSes in DREG-CMD BS also broadcasts UST+UTI+system parameters. This enables all the users (connected, idle, scanning) to be potentially reached. However this has relatively more overhead than approaches.

Still other embodiments of the present invention provide that the BS may use other approaches such as: a) scheduling the SON restart in such a way that it coincides with the sleep time of all the attached MSes; b) scheduling the SON restart when there are no attached MSes; c) doing network controlled HO of all the attached MSs in the event that there is coverage from other BSes in the vicinity; and d) doing RF carrier switching of all the attached MSes to a stable RF carrier, in the event that the BS supports multi carrier.

Yet other embodiments of the present invention provide a method comprising operating a base station (BS) in a wireless network and adapting the BS to reconfigure RF operational parameters on a dynamic basis enabling self optimizing networks (SON); and maintaining session continuity by the BS with at least one STA through SON restarts. The continuity may be maintained by using a Deregistration command (DREG-CMD) such that when said BS is being asked to restart its operation by a SON server, the BS can send the DREG-CMD message to all STAs that are attached to it and the DREG-CMD code is defined and used for the specific purpose of SON restart of the BS, and wherein when the code is used in the DREG-CMD and an MS receives it, the MS will immediately know that this de-registration is for SON purposes and hence it is a temporary one.

Still another embodiment of the present invention provides a computer readable medium encoded with computer executable instructions, which when accessed, cause a machine to perform operations comprising, operating a base station (BS) in a wireless network and adapting the BS to reconfigure RF operational parameters on a dynamic basis enabling self optimizing networks (SON), and maintaining session continuity by the BS with at least one STA through SON restarts. Again, the continuity may be maintained by said computer readable medium by using a Deregistration command (DREG-CMD) such that when said BS is being asked to restart its operation by a SON server, the BS can send the DREG-CMD message to all STAs that are attached to it and the DREG-CMD code is defined and used for the specific purpose of SON restart of the BS, and wherein when the code is used in the DREG-CMD and an MS receives it, the MS will immediately know that this de-registration is for SON purposes and hence it is a temporary one.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

We claim:

1. A base station (BS), comprising:
a transceiver adapted for communication with at least one mobile station (MS) in a wireless network and further adapted to reconfigure RF operational parameters on a dynamic basis enabling self optimizing networks (SON); and
wherein said BS is capable of maintaining session continuity with said at least one STA through SON restarts.

2. The BS of claim 1, wherein said continuity is maintained by using a Deregistration command (DREG-CMD) such that when said BS is being asked to restart its operation by a SON server, said BS can send said DREG-CMD message to all STAs that are attached to it and said DREG-CMD code is defined and used for the specific purpose of SON restart of said BS; and
wherein when said code is used in said DREG-CMD and an MS receives it, said MS will immediately know that this de-registration is for SON purposes and hence it is a temporary one.

3. The BS of claim 2, wherein included in said DREG-CMD is Unavailable time Interval (UTI) of said BS and new system parameters of said BS, post reconfiguration, for network re-entry of the MS.

4. The BS of claim 3, wherein in order to maintain session continuity of said MS, said BS also indicates said restart to a ASN-GW to start buffering data in a GW for said MS and wherein said BS and said MS maintain medium access control (MAC) context after DREG-CMD to enable fast network re-entry.

5. The BS of claim 4, wherein when said MS receives said DREG-CMD message and deregisters itself from said BS, said MS waits until said UTI expires and then said MS scans for said BS again with the new system parameters and said MS performs fast re-entry with existing MAC context and an MS Session is not lost.

6. The BS of claim 1, wherein said continuity is maintained by broadcasting relevant info for re-attach before said SON reconfiguration.

7. The BS of claim 6, where said BS broadcasts: a) Unavailability start time (UST); b) Unavailable Time Interval (UTI) of the BS; and c) New system parameters for network re-entry of the MS, once the BS becomes available.

8. The BS of claim 7, wherein said BS also indicates UST, UTI and system parameters to an ASN-GW to start buffering data in a GW for said MS.

9. The BS of claim 6, wherein in order to maintain the session continuity of said MS, said BS also indicates said restart to said ASN-GW to start buffering said data in said GW for said MS.

10. The BS of claim 9 wherein all attached MSs get said message and detach themselves from said BS starting at UST and then said MSs wait until said UTI expires and said MSs then scan for said BS again with the new system parameters and said MS then performs fast re-entry with existing MAC context and said MS Session is not lost.

11. The BS of claim 8, wherein said continuity is maintained by said BS unicasting said UTI and said system parameters to all attached MSs and wherein said DREG-CMD BS also broadcasts a UST as well as said UTI and said system parameters.

12. The BS of claim 1, wherein said continuity is maintained by scheduling said SON restart in such a way that it coincides with a sleep time of all attached mobile stations.

13. The BS of claim 1, wherein said continuity is maintained by scheduling said SON restart when there are no attached mobile stations.

14. The BS of claim 1, wherein said continuity is maintained by doing network controlled HO of all attached mobile stations in an event that there is coverage from other BSes in the vicinity.

15. The BS of claim 1, wherein said continuity is maintained by doing RF carrier switching of all the attached mobile stations to a stable RF carrier, in the event that said BS supports multi carrier.

16. A method comprising:
operating a base station (BS) in a wireless network and adapting said BS to reconfigure RF operational parameters on a dynamic basis enabling self optimizing networks (SON); and
maintaining session continuity by said BS with at least one STA through SON restarts.

17. The method of claim 16, wherein said continuity is maintained by using a Deregistration command (DREG-CMD) such that when said BS is being asked to restart its operation by a SON server, said BS can send said DREG-CMD message to all STAs that are attached to it and said DREG-CMD code is defined and used for the specific purpose of SON restart of said BS; and
wherein when said code is used in said DREG-CMD and an MS receives it, said MS will immediately know that this de-registration is for SON purposes and hence it is a temporary one.

18. The method of claim 17, wherein included in said DREG-CMD is Unavailable time Interval (UTI) of said BS and new system parameters of said BS, post reconfiguration, for network re-entry of the MS.

19. The method of claim 18, wherein in order to maintain session continuity of said MS, said BS also indicates said restart to a ASN-GW to start buffering data in a GW for said MS and wherein said BS and said MS maintain medium access control (MAC) context after DREG-CMD to enable fast network re-entry.

20. The method of claim 19, wherein when said MS receives said DREG-CMD message and deregisters itself from said BS, said MS waits until said UTI expires and then said MS scans for said BS again with the new system parameters and said MS performs fast re-entry with existing MAC context and an MS Session is not lost.

21. The method of claim 16, wherein said continuity is maintained by broadcasting relevant info for re-attach before said SON reconfiguration.

22. The method of claim 21, where said BS broadcasts: a) Unavailability start time (UST); b) Unavailable Time Interval (UTI) of the BS; and c) New system parameters for network re-entry of the MS, once the BS becomes available.

23. The method of claim 22, wherein said BS also indicates UST, UTI and system parameters to an ASN-GW to start buffering data in a GW for said MS.

24. The method of claim 21, wherein in order to maintain the session continuity of said MS, said BS also indicates said restart to said ASN-GW to start buffering said data in said GW for said MS.

25. The method of claim 24 wherein all attached MSs get said message and detach themselves from said BS starting at UST and then said MSs wait until said UTI expires and said MSs then scan for said BS again with the new system parameters and said MS then performs fast re-entry with existing MAC context and said MS Session is not lost.

26. The method of claim 23, wherein said continuity is maintained by said BS unicasting said UTI and said system parameters to all attached MSs and wherein said DREG-CMD BS also broadcasts a UST as well as said UTI and said system parameters.

27. The method of claim 16, wherein said continuity is maintained by scheduling said SON restart in such a way that it coincides with a sleep time of all attached mobile stations.

28. The method of claim 16, wherein said continuity is maintained by scheduling said SON restart when there are no attached mobile stations.

29. The method of claim 16, wherein said continuity is maintained by doing network controlled HO of all attached mobile stations in an event that there is coverage from other BSes in the vicinity.

30. The method of claim 16, wherein said continuity is maintained by doing RF carrier switching of all the attached mobile stations to a stable RF carrier, in the event that said BS supports multi carrier.

31. A base station (BS), comprising:
a transceiver adapted for communication with at least one mobile station (MS) in a wireless network and further adapted to reconfigure RF operational parameters on a dynamic basis enabling self optimizing networks (SON); and
wherein said BS is capable of maintaining session continuity with said at least one STA through SON restarts by broadcasting relevant information for re-attach before said SON reconfiguration.

32. The BS of claim 31, wherein said BS broadcasts the following information: a) Unavailability start time (UST); b) Unavailable Time Interval (UTI) of the BS; and c) New system parameters for network re-entry of the MS, once the BS becomes available.

33. The BS of claim 32, wherein said BS also indicates said information to a ASN-GW to start buffering data in said GW for said MS and wherein in order to maintain session continuity of said MS, said BS also indicates this restart to said ASN-GW to start buffering the data in said GW for said MS.

34. The BS of claim 33, wherein all attached MSs get a message and detach themselves from said BS starting UST, then they wait until said UTI expires and then they scan for said BS again with new system parameters and said MS then performs fast re-entry with existing MAC context and an MS Session is not lost.
